(19) United States
(12) Patent Application Publication
(10) Pub. No.: US 2025/0254246 A1
(43) Pub. Date: Aug. 7, 2025

(54) IMAGE FORMING SYSTEM FOR PERFORMING LOG DATA TRANSMISSION AND RECEPTION BETWEEN IMAGE FORMING APPARATUS AND SERVER AND IMAGE FORMING APPARATUS

(71) Applicant: KYOCERA Document Solutions Inc., Osaka (JP)

(72) Inventors: Shuntaro TSUJI, Osaka (JP); Hironori OKAMOTO, Osaka (JP)

(73) Assignee: KYOCERA Document Solutions Inc., Osaka (JP)

(21) Appl. No.: 19/037,745

(22) Filed: Jan. 27, 2025

(30) Foreign Application Priority Data
Feb. 2, 2024 (JP) 2024-015254

(51) Int. Cl. H04N 1/00; G06F 11/34

(52) U.S. Cl. CPC H04N 1/00079; G06F 11/3476

(57) ABSTRACT

An image forming system including a server and an image forming apparatus. The image forming apparatus includes a first communication device, a first storage device, and a first control device as a first controller. The first control device generates log data related to an operation of the image forming apparatus, causes the first storage device to store the log data, generate log data segments by dividing log data for a certain period into a predetermined data amount or less when a log data generation period has reached the certain period, and causes the first communication device to transmit the log data segments to the server. The server includes a second communication device, a second storage device, and a second control device as a second controller. When the second communication device receives the log data segments, the second controller causes the second storage device to store the log data segments.

### INCORPORATION BY REFERENCE

This application claims priority to Japanese Patent Application No. 2024-015254 filed on 2 Feb. 2024, the entire contents of which are incorporated by reference herein.

### BACKGROUND

The present disclosure relates to an image forming apparatus that mutually performs data communication with a server, an image forming system including the image forming apparatus and the server, and in particular relates to technology for collecting log information related to an operation of the image forming apparatus.

In the image forming apparatus, an image reading device reads an image of a manuscript and an image forming device forms the image of the manuscript on recording paper. As this image forming apparatus, an image forming apparatus having a function of generating and storing log data related to an operation of the image forming apparatus is known. The log data is analyzed to properly perform maintenance of the image forming apparatus. For example, the user connects a universal serial bus (USB) memory to the image forming apparatus, stores the log data in the USB memory, and hands the USB memory over to a service member or the like.

Moreover, a remote management system in which a survival confirmation message is transmitted to a relay server when a relay management server accepts a connection for operating a remote panel from a user terminal and an image forming apparatus is known. In this remote management system, when the survival confirmation message is received, the relay server confirms whether or not the capacity of the connection handled by the relay server has reached an upper limit and replies with an acceptable new request message or an unacceptable new request message.

When the acceptable new request message is received, the relay management server forwards the accepted connection to a relay server that has returned the acceptable new request message. When the unacceptable new request message is received, the relay management server transmits a survival confirmation message to another relay server. Thereby, even if the capacity of the relay server exceeds the limit, a remote panel function can be continued.

### SUMMARY

As an aspect of the present disclosure, technology obtained by further improving the above-described technology is proposed. According to an aspect of the present disclosure, an image forming system includes a server and an image forming apparatus. The image forming apparatus includes a first communication device, a first storage device, and a first control device. The first communication device performs data communication with the server. The first control device includes a processor and functions as a first controller when the processor executes a first control program. The first controller generates log data related to an operation of the image forming apparatus, causes the first storage device to store the log data, generates, when a log data generation period has reached a certain period set in advance, log data segments by dividing log data for the certain period into a predetermined data amount or less, and causes the first communication device to transmit the log data segments to the server. The server includes a second communication device, a second storage device, and a second control device. The second communication device performs data communication with the image forming apparatus. The second control device includes a processor and functions as a second controller when the processor executes a second control program. The second control device causes the second storage device to store the log data segments when the second communication device receives the log data segments.

According to another aspect of the present disclosure, an image forming apparatus includes a first communication device, a first storage device, and a first control device. The first communication device performs data communication with a server. The first control device includes a processor and functions as a first controller when the processor executes a first control program. The first controller generates log data related to an operation of the image forming apparatus, causes the first storage device to store the log data, generates, when a log data generation period has reached a certain period set in advance, log data segments by dividing log data for the certain period into a predetermined data amount or less, and causes the first communication device to transmit the log data segments to the server.

### BRIEF DESCRIPTION OF THE DRAWINGS

FIG. 1 is a block diagram showing a configuration of an image forming apparatus and a configuration of a server provided in an image forming system.

FIGS. 2A and 2B are flowcharts showing a log data transmission/reception process.

FIG. 3 is a diagram showing an example of a warning screen.

### DETAILED DESCRIPTION

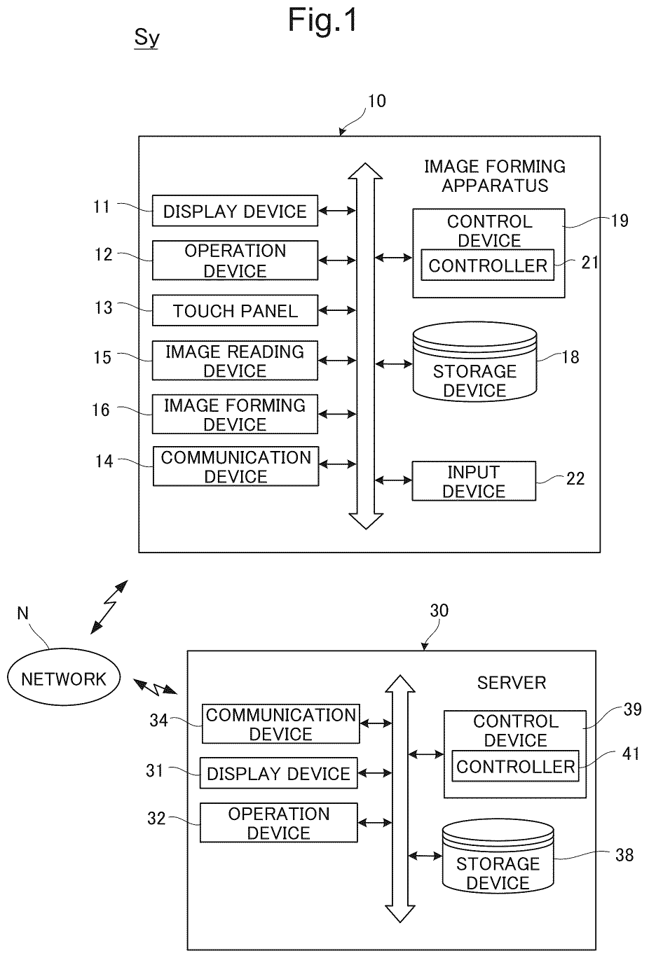

Hereinafter, an image forming apparatus and an image forming system according to embodiments of the present disclosure will be described with reference to the drawings. FIG. 1 is a block diagram showing a configuration of an image forming apparatus 10 and a configuration of a server 30 provided in an image forming system Sy according to an embodiment of the present disclosure.

The image forming system Sy includes one or more image forming apparatuses 10 and a server 30. The image forming apparatus 10 and the server 30 are connected to each other via a network (such as the Internet or an intranet) N. In the present embodiment, the image forming system Sy includes a plurality of image forming apparatuses 10.

### [Configuration of Image Forming Apparatus 10]

The image forming apparatus 10, for example, is a multifunction printer (MFP) (a multifunction machine) in which a plurality of functions such as a copy function and a scanner function are combined. The image forming apparatus 10 includes a display device 11, an operation device 12, a touch panel 13, a communication device 14, an image reading device 15, an image forming device 16, a storage device 18, an input device 22, a control device 19, and the like. These constituent elements can transmit and receive data or signals to and from each other through a bus.

The display device 11 includes a liquid crystal display (LCD), an organic electroluminescence (EL) (OLED: Organic Light-Emitting Diode) display, or the like.

The touch panel 13 is superimposed on a screen of the display device 11. The touch panel 13 detects the contact (touch) of the user's finger with the touch panel 13 together with a contact position and outputs a detection signal indicating coordinates of the contact position to the controller 21 of the control device 19. Thereby, it is possible to manipulate a graphical user interface (GUI) or the like displayed on the screen of the display device 11 through the touch panel 13. The touch panel 13 functions as an operation device in which the user's operation on the screen of the display device 11 is input.

The operation device 12 includes a hard key such as a numeric keypad, a decision key, or a start key. The operation device 12 receives various types of instructions on the basis of operations of keys by the user.

The image reading device 15 includes a scanner that optically reads an image of a manuscript. The image reading device 15 generates image data indicating an image of the manuscript.

The image forming device 16 includes a photoconductor drum, an electric charging device, an exposure device, a developing device, a transfer device, and the like. The electric charging device uniformly charges the surface of the photoconductor drum. The exposure device exposes the surface of the photoconductor drum to form an electrostatic latent image on the surface of the photoconductor drum. The developing device develops the electrostatic latent image on the surface of the photoconductor drum onto a toner image. The transfer device transfers the toner image (image) on the surface of the photoconductor drum to recording paper. The image forming device 16 prints an image indicated in the image data on the recording paper.

The communication device 14 is a communication interface including a communication module such as a local area network (LAN) chip. The communication device 14 is connected to the server 30 through the network N and performs data communication with the server 30.

The storage device 18 is a large-capacity storage device such as a solid-state drive (SSD) or a hard disk drive (HDD). The storage device 18 stores various types of application programs and various types of data.

The input device 22 is, for example, a USB interface. The input device 22 inputs data from a USB memory or the like.

The control device 19 includes a processor, a random-access memory (RAM), a read-only memory (ROM), and the like. The processor can be, for example, a central processing unit (CPU), an application specific integrated circuit (ASIC), a micro processing unit (MPU), or the like. The control device 19 functions as the controller 21 when the processor executes a control program stored in the ROM or the storage device 18.

The control device 19 is connected to the display device 11, the operation device 12, the touch panel 13, the communication device 14, the image reading device 15, the image forming device 16, the storage device 18, the input device 22, and the like. The controller 21 controls each of the above-described constituent elements and transmits and receives signals or data to and from each constituent element.

The controller 21 controls the overall operation of the image forming apparatus 10. The controller 21 plays a role as a processing device that executes various processes. The controller 21 has a function of controlling the display device 11 and the communication device 14.

### [Configuration of Server 30]

The server 30 is connected to the image forming apparatus 10 via the network N, and transmits and receives data to and from the image forming apparatus 10. The server 30 includes a display device 31, an operation device 32, a communication device 34, a storage device 38, a control device 39, and the like. These constituent elements can transmit and receive data or signals to and from each other through the bus.

The communication device 34 is a communication interface. The communication device 34 is connected to the image forming apparatus 10 via the network N and transmits and receives data to and from the image forming apparatus 10.

The storage device 38 is a storage device such as an SSD or HDD. The storage device 38 stores programs and various types of data.

The control device 39 includes a processor, a RAM, a ROM, and the like. The control device 39 functions as a controller 41 when the processor executes a program stored in the ROM or the storage device 38.

The control device 39 is connected to the display device 31, the operation device 32, the communication device 34, the storage device 38, and the like. The controller 41 controls each of the above-described constituent elements and transmits and receives signals or data to and from each constituent element.

The controller 41 controls the overall operation of the server 30. The controller 41 plays a role as a processing device that executes various processes. The controller 41 has a function of controlling the display device 31 and the communication device 34.

In the image forming apparatus 10, for example, the user sets a manuscript on the image reading device 15 and manipulates a start key of the operation device 12. The controller 21 of the image forming apparatus 10 causes the image reading device 15 to read the image of the manuscript and causes the image forming device 16 to print the image of the manuscript on the recording paper in accordance with a copy instruction received by the operation device 12 in response to the operation of the start key.

During the operation of the image forming apparatus 10, the controller 21 of the image forming apparatus 10 generates a plurality of types of log data according to (i) a process of forming log data indicating the number of sheets of recording paper and color, monochrome, or the like every time an image of the manuscript is formed on the recording paper, (ii) a process of generating log data indicating an error every time the error occurs, (iii) a process of generating log data indicating the total number of sheets of recording paper by counting the total number of sheets of recording paper used on which the image is formed, (iv) a process of generating log data indicating an amount of used toner by counting the amount of used toner, and the like and causes the storage device 18 to separately store log data according to various types of log data.

The controller 21 of the image forming apparatus 10 reads the log data from the storage device 18 at a predetermined timing and causes the communication device 14 to transmit the read log data to the server 30 through the network N.

When the communication device 34 receives the log data, the controller 41 of the server 30 causes the storage device 38 to store the log data. The service member accesses the server from an external personal computer (PC) and acquires log data read from the storage device 38 by the controller 41 from the server 30. Alternatively, the service member operates the server 30, causes the controller 41 to read the log data from the storage device 38, causes the read log data to be displayed on the screen of the display device 31, and refer to the displayed log data. Thereby, the service member remotely ascertains an operating state of the image forming apparatus 10.

The plurality of image forming apparatuses 10 transmit the acquired log data to the server 30. Therefore, a large amount of log data of each image forming apparatus 10 is transmitted from each image forming apparatus 10 to the server 30 through the network N and stored in the storage device 38 of the server 30. For this reason, the server 30 needs to appropriately manage an available storage capacity of the storage device 38 or a communication time of the log data. For example, if the available storage capacity of the storage device 38 is insufficient, the server 30 cannot store the log data of the image forming apparatus 10. If the communication time in which log data is received becomes excessively long, other data communication will be blocked.

On the other hand, in the image forming system Sy of the present embodiment, an allocated storage capacity of the storage device 38 of the server 30 for storing log data of one image forming apparatus 10 (hereinafter referred to as an “allocated capacity”) is set in advance. Thereby, the allocated capacity of the storage device 38 of the server 30 is continuously secured for each image forming apparatus 10.

The controller 21 of the image forming apparatus 10 generates log data during the operation of the image forming apparatus 10, causes the storage device 18 to store the log data, and determines whether or not a data amount of saved log data is less than or equal to an allocated capacity when the period becomes a certain period set in advance (for example, a designated period designated from the server 30). When the data amount of log data for the above-described certain period is less than or equal to the allocated capacity, the controller 21 causes the communication device 14 to transmit the log data for the certain period to the server 30 through the network N.

When the data amount of log data for the certain period exceeds the allocated capacity, the controller 21 of the image forming apparatus 10 divides the log data for the certain period, generates a plurality of log data items with the allocated capacity or less, and causes the communication device 14 to transmit the plurality of generated log data items with the allocated capacity or less to the server 30 through the network N at transmission timings different from each other.

The controller 41 of the server 30 calculates the communication time of the log data received from the image forming apparatus 10 and causes the communication device 34 to transmit an instruction to request stopping of the transmission of the log data as the reception target, a retransmission in which a data amount of the log data as the reception target is reduced, or shortening of a designated period through the network N to the image forming apparatus 10 when the calculated communication time exceeds a specified time set in advance.

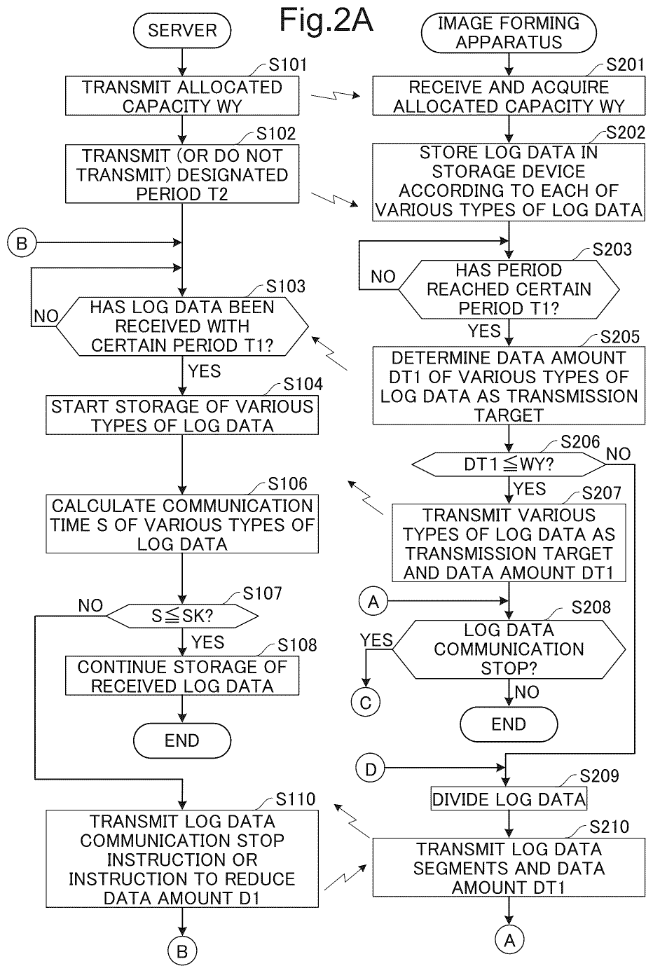

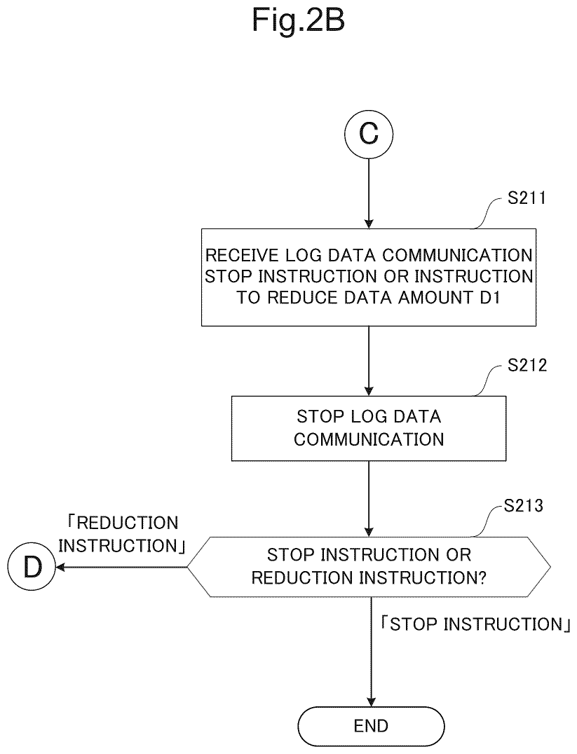

Next, in the image forming system Sy, a log data transmission/reception process executed when the image forming apparatus 10 transmits log data to the server 30 will be described with reference to the flowcharts shown in FIGS. 2A and 2B and the like.

In the server 30, the operation device 32 receives a storage capacity (an allocated capacity) WY of the storage device 38 allocated for storing the log data of each image forming apparatus 10 according to an operation of the service member. The controller 41 transmits the received allocated capacity WY to the communication device 34 to each image forming apparatus 10 through the network N (step S101).

Each image forming apparatus 10 receives and sets the allocated capacity WY As described above, the allocated capacity WY is the storage capacity of the storage device 38 of the server 30 allocated for storing log data of one image forming apparatus 10.

Furthermore, in the server 30, when the operation device 32 receives a designated period T2 according to the operation of the service member, the controller 41 causes the communication device 34 to transmit the designated period T2 to the image forming apparatus 10 through the network N (step S102). The designated period T2 is, for example, 7 days. The designated period T2 is received by the communication device 34 of the image forming apparatus 10.

In the image forming apparatus 10, when the communication device 34 receives the allocated capacity WY, the controller 21 acquires the allocated capacity WY (step S201). The controller 21 of the image forming apparatus 10 generates the above-described plurality of log data items during the operation of the image forming apparatus 10 and causes the storage device 18 to separately store the log data according to various types of log data (step S202).

The controller 21 determines whether or not the log data generation period Δt has reached a certain period T1 set in advance (step S203). When the communication device 34 has received the designated period T2, the controller 21 sets the designated period T2 as the certain period T1.

When the communication device 34 has not received the designated period T2, the controller 21 sets a period preset in the controller 21 (for example, the period (30 days or the like) received by the operation device 12 or the touch panel 13 in the operation of the user) as the certain period T1.

The controller 21 continuously generates and stores log data until a log data generation period Δt reaches the certain period T1 (for example, 30 days) (step S203 “No”).

When it is determined that the log data generation period Δt has reached the certain period T1 (step S203 “Yes”), the controller 21 reads various types of log data for the certain period T1 during an operation period of the image forming apparatus 10 from the storage device 18 and determines a data amount DT1 of various types of log data in the certain period T1 (step S205).

The controller 21 determines whether or not the data amount DT1 is less than or equal to the allocated capacity WY (step S206). In addition, the controller 21 counts the certain period T1 only in a state in which the image forming apparatus 10 is operating. The controller 21 pauses the counting of the certain period T1 when the image forming apparatus 10 has paused the operation and resumes the counting of the certain period T1 from the value at the time of the pause when the operation has been resumed.

When it is determined that the data amount DT1 of various types of log data for the certain period T1 is less than or equal to the allocated capacity WY (step S206 “Yes”), the controller 21 causes the communication device 14 to transmit various types of log data (including acquisition timepoint information indicating the acquisition timepoint of various types of log data) and data amount information indicating a data amount DT1 (the total data amount of various types of log data) to the server 30 through the network N (step S207).

After the processing of step S207, unless the communication device 14 receives a log data communication stop instruction from the server 30 (step S208 “No”), the controller 21 continues a process of transmitting various types of log data and data amount information stored for the certain period T1 to the server 30 and ends a log data transmission/reception process shown in FIG. 2A at a timepoint when the transmission of the log data or the like has been completed.

On the other hand, in the server 30, when the communication device 34 receives various types of log data and data amount information for the certain period T1 (step S103 “Yes”), the controller 41 starts the storage of various types of log data in the storage device 38 (step S104).

The controller 41 determines an amount of data per unit time received by the communication device 34, i.e., a communication rate, and calculates a communication time S required for communication of various types of log data from the communication rate and the data amount DT1 of the log data (step S106). The controller 41 determines whether or not the communication time S is less than or equal to a specified time SK set in advance (step S107). The specified time SK is, for example, 30 minutes.

When it is determined that the communication time S is less than or equal to the specified time SK (step S107 “Yes”), the controller 41 of the server 30 continues a process of receiving and storing various types of log data because the communication of various types of log data ends within the specified time SK (step S108) and ends a log data transmission/reception process shown in FIG. 2A when the storage of various types of log data for the storage device 38 has been completed.

Thus, when the communication time S of various types of log data of the data amount DT1 less than or equal to the allocated capacity WY in the certain period T1 is less than or equal to the specified time SK, various types of log data in the certain period T1 are transmitted and received from the image forming apparatus 10 to the server 30 and stored in the storage device 38.

On the other hand, in step S206, the controller 21 of the image forming apparatus 10 divides various types of log data in the certain period T1 into a plurality of log data items (hereinafter referred to as “log data segments”) with the allocated capacity WY or less (step S209) when it is determined that the data amount DT1 of the various types of log data in the certain period T1 exceeds the allocated capacity WY (step S206 “No”).

The controller 21 divides various types of log data in the certain period T1 into a plurality of log data segments with a predetermined data amount or less. The predetermined data amount is, for example, a data amount for a case where various types of log data in the certain period T1 are divided in a unit of 1 hour on the basis of a generation timepoint (in this case, the certain period T1 is, for example, 6 hours, or the like) or a data amount for a case where various types of log data in the certain period T1 are divided in a unit of 1 day (24 hours) (in this case, the certain period T1 is, for example, 7 days, or the like).

The controller 21 may generate log data segments with the allocated capacity WY or less on the basis of a data amount of various types of log data in the certain period T1 as follows. For example, when the allocated capacity WY is 1 GB and the data amount DT1 of various types of log data in the certain period T1 is 2 GB, various types of log data in the certain period T1 is divided into two 1-GB log data segments.

The above-described division is performed under the condition that the log data segments generated by the division have the allocated capacity WY or less.

The controller 21 determines the data amount DT1 for each log data segment. The controller 21 causes the communication device 14 to transmit each log data segment (including acquisition timepoint information indicating the acquisition timepoint of various types of log data) and data amount information indicating the data amount DT1 to the server 30 through the network N in a predetermined order (step S210). The predetermined order is, for example, the order based on the earliest generation timepoint of the log data or the like.

In the server 30, when the communication device 34 has started the reception of the log data segments and the data amount information (step S103), the controller 41 starts the storage of the log data segments in the storage device 38 from the first received log data segment (step S104). In this case, the controller 41 determines whether the communication time S is less than or equal to the specified time SK from the first received log data segment for each log data segment (steps S106 and S107).

The controller 41 continues the process of storing the log data segments (step S108) under the condition that the communication of the log data segments ends within the specified time SK (“Yes” in step S107). At a timepoint when the storage process in the storage device 38 for all of the series of log data transmitted from the image forming apparatus 10 has ended, the controller 41 ends the log data transmission/reception process shown in FIG. 2A.

When the remaining capacity of the storage device 38 runs out during the process of storing a series of log data segments and the storage process cannot be continued, the controller 41 causes the communication device 34 to transmit a log data communication stop instruction, unstorable data information indicating a log data segment for which the storage process is impossible, and retransmission timepoint information indicating a timepoint when a log data segment for which the storage process is impossible is retransmitted to the image forming apparatus 10.

For example, when a process of deleting log data stored in the storage device 38 of the server 30 from the oldest log data every 3 hours is set, the retransmission timepoint information is about a timepoint that is 3 hours after a timepoint when the above-described storage process cannot be continued.

In the image forming apparatus 10, when the communication device 14 receives a log data communication stop instruction, unstorable data information, and retransmission timepoint information, the controller 21 causes the communication device 14 to stop the log data segment transmission process and retransmit the log data segment indicated in the unstorable data information to the server 30 at a timepoint indicated in the retransmission timepoint information. After the log data segment retransmission, the server 30 performs a process from steps S103 to S108.

In addition, in the image forming apparatus 1, after step S210, the controller 21 continues the process of transmitting each log data segment and data amount information to the server 30 unless the communication device 14 receives a log data communication stop instruction from the server 30 (step S208 “No”) and ends the log data transmission/reception process shown in FIG. 2A at a timepoint when the transmission of all of the log data segments and the like has been completed.

On the other hand, when it is determined that the communication time S of the log data (or log data segment) received from the image forming apparatus 10 exceeds the specified time SK (step S107 “No”), the controller 41 of the server 30 causes the communication device 34 to transmit a log data communication stop instruction or an instruction to reduce the data amount DT1 of the log data to the image forming apparatus 10 through the network N (step S110). After the processing of step S110, the process of the server 30 proceeds to step S103.

In the image forming apparatus 10, when the communication device 14 receives the log data communication stop instruction or the instruction to reduce the data amount DT1 of the log data (step S208 “Yes” and step S211 of FIG. 2B), the controller 21 causes the communication device 14 to stop the log data (or log data segment) transmission (step S212).

When the received instruction is the log data communication stop instruction (“stop instruction” in step S213), the controller 21 ends the log data transmission/reception process. When the received instruction is the instruction to reduce the data amount DT1 of the log data (“reduction instruction” in step S213), the controller 21 divides the log data (or log data segment) of the communication target (step S209).

For example, the controller 21 divides the log data (or log data segment) of the communication target into two and generates two log data segments in which the data amount is halved. The controller 21 determines the data amount DT1 for each log data segment and causes the communication device 14 to transmit each log data segment (including acquisition timepoint information indicating a timepoint when various types of log data are acquired) and data amount information indicating the data amount DT1 of each log data segment to the server 30 through the network N (step S210). After the processing of step S210, the process of the image forming apparatus 10 proceeds to step S208.

On the other hand, in the server 30, when the communication device 34 receives the log data segment and the data amount information (step S103 “Yes”), the controller 41 executes a process from step S104.

Meanwhile, when log data is stored in a USB memory as in the above-described general image forming apparatus and this USB memory is handed over to a service member or the like, it is not desirable from the viewpoint of security in consideration of the loss of the USB memory or the like.

On the other hand, the log data of the image forming apparatus may be transmitted to the server via the network and the log data may be stored and managed in the server. However, when the log data of a plurality of image forming apparatuses is transmitted to the server for storage, it is necessary to appropriately manage the available storage capacity of the server or the communication time of the log data. For example, if the available storage capacity of the server is insufficient, the log data of a plurality of image forming apparatuses cannot be stored. If the communication time of the log data becomes excessively long, other data communication will be blocked.

In the above-described general remote management system, connections for remote panel execution from user terminals and image forming apparatuses are distributed to a plurality of relay servers via a relay management server. It is conceivable that this remote control system technology can be applied to distribute the log data of the image forming apparatus to a plurality of servers and transmit the log data for storage. However, in this case, because the log data of each image forming apparatus is distributed on a plurality of servers, it becomes difficult to collectively manage the log data of the image forming apparatuses.

On the other hand, according to the above-described embodiment, when the log data related to the operation of the image forming apparatus 10 is transmitted from the image forming apparatus 10 to the server 30, it is possible to reliably store the log data in the storage device 38 of the server 30. Moreover, it is possible to collectively manage the log data of the image forming apparatuses.

Next, another embodiment of the log data transmission/reception process will be described. The other embodiment is similar to the above-described embodiment except for the processing shown below.

In the above-described embodiment, when it is determined that the data amount DT1 of the various types of log data in the certain period T1 exceeds the allocated capacity WY (step S206 “No”), the controller 21 of the image forming apparatus 10 causes the communication device 14 to divide various types of log data in the certain period T1 and transmit the log data segments to the server 30 in a predetermined order (step S210).

On the other hand, in the other embodiment, when it is determined that the data amount DT1 of the various types of log data exceeds the allocated capacity WY in the certain period T1 (step S206 “No”), the controller 21 causes the communication device 14 to transmit a priority transmission request for various types of log data to the server 30.

In the server 30, when the communication device 34 receives a transmission request for priorities of the various types of log data, the controller 41 causes the communication device 34 to transmit a priority of each type of log data stored in advance in the storage device 38 or the like or a priority of each type of log data based on a priority input to the operation device 32 of the service member to the image forming apparatus 10.

For example, when (i) log data generated every time an image of a manuscript is formed on recording paper, (ii) log data indicating an error generated every time the error occurs, (iii) log data indicating the total number of used sheets of recording paper, and (iv) log data indicating toner usage are recorded and priorities are set as a first place (i), a second place (ii), a third place (iv), and a fourth place (iii):

In the image forming apparatus 10, when the communication device 34 receives the priorities of the various types of log data, the controller 21 divides the various types of log data in the certain period T1 according to each type whose priority is set on the basis of the priorities of the various types of log data and calculates a data amount of log data segments.

The controller 21 causes the communication device 14 to start the transmission for the server 30 in order from the log data segment of the highest priority type. The division is also performed under the condition that the log data segment has the allocated capacity WY or less.

Moreover, in the other embodiment, when the remaining capacity of the storage device 38 runs out during the process of storing a series of log data segments and the storage process cannot be continued, the controller 41 of the server 30 causes the communication device 34 to transmit a log data communication stop instruction, unstorable data information indicating a log data segment for which the storage process is impossible, and retransmission timepoint information indicating a timepoint when a log data segment for which the storage process is impossible is retransmitted to the image forming apparatus 10.

When the communication device 14 receives the log data communication stop instruction, the unstorable data information, and the retransmission timepoint information in the image forming apparatus 10, the controller 21 causes the communication device 14 to stop the transmission process of transmitting in order from the log data segment of the high priority type. The controller 21 causes the communication device 14 to retransmit the log data segment indicated in the unstorable data information to the server 30 at a timepoint indicated in the retransmission timepoint information. After the log data segment is retransmitted, the server 30 performs the process from steps S103 to S108.

In addition, the controller 41 of the server 30 may cause the communication device 34 to transmit the priority to the image forming apparatus 10 together with the allocated capacity WY at the time of the transmission of the allocated capacity WY in step S101. In this case, because the image forming apparatus 10 has a priority at the timepoint when the determination result becomes No in step S206, the controller 21 divides various types of log data in the certain period T1 and transmits log data segments in the order according to priorities of the log data segments without transmitting a priority transmission request to the server 30.

Moreover, as described above, when it is determined that the communication time S of the log data received from the image forming apparatus 10 exceeds the specified time SK (step S107 “No”), the controller 41 of the server 30 transmits the log data communication stop instruction or the instruction to reduce the data amount DT1 of the log data to the image forming apparatus 10 (step S110). At this time, the controller 41 may cause the communication device 34 to transmit an instruction to request the shortening of the designated period T2 together with the communication stop instruction and the reduction instruction to the image forming apparatus 10.

In this case, in the image forming apparatus 10, when the communication device 14 receives the instruction to request the shortening, the controller 21 sets a new certain period T10 by shortening the certain period T1 at a present timepoint according to content indicated in the instruction to request the shortening, for example, the shortening of the certain period T1 by 50% at the present timepoint and performs the subsequent generation and transmission of log data segments on the basis of the new certain period T10.

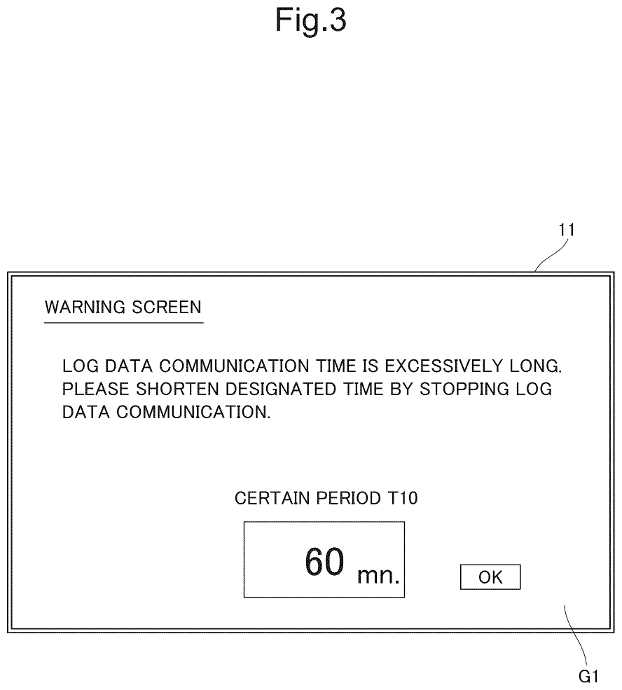

Alternatively, when the communication device 14 receives the instruction to request the shortening, the controller 21 may prompt the user to input the new certain period T10 by displaying a warning screen G1 shown in the example in FIG. 3 on the display device 11. After the warning screen G1 is displayed, when the new certain period T10 is input to the operation device 12 or the touch panel 13 according to an operation of the user, the controller 21 sets the new certain period T10 and performs the subsequent generation and transmission of log data segments on the basis of the new certain period T10.

This facilitates the generation of log data segments by the data amount that fits within the allocated capacity WY.

The configuration and process of the above-described embodiment described with reference to FIGS. 1 to 3 are only examples of the present disclosure and the present disclosure is not intended to be limited to the configuration and process.

While the present disclosure has been described in detail with reference to the embodiments thereof, it would be apparent to those skilled in the art the various changes and modifications may be made therein within the scope defined by the appended claims.

What is claimed is:

1. An image forming system including a server and an image forming apparatus,
wherein the image forming apparatus includes
a first communication device that performs data communication with the server; and
a first storage device; and
a first control device that includes a processor and functions, when the processor executes a first control program, as a first controller that generates log data related to an operation of the image forming apparatus, cause the first storage device to store the log data, generates, when a log data generation period has reached a certain period set in advance, log data segments by dividing log data for the certain period into a predetermined data amount or less, and causes the first communication device to transmit the log data segments to the server, and
wherein the server includes
a second communication device that performs data communication with the image forming apparatus;
a second storage device; and
a second control device that includes a processor and functions, when the processor executes a second control program, as a second controller that causes the second storage device to store the log data segments when the second communication device receives the log data segments.

2. The image forming system according to claim 1,
wherein the first controller of the image forming apparatus
determines, when the first communication device receives an allocated capacity transmitted from the server, whether or not a data amount of the log data for the certain period is less than or equal to the allocated capacity,
causes the first communication device to transmit the log data for the certain period to the server without performing the division when the data amount of the log data for the certain period is less than or equal to the allocated capacity, and
generates log data segments by dividing the log data for the certain period into the allocated capacity or less and causes the first communication device to transmit the log data segments to the server when the data amount of the log data for the certain period exceeds the allocated capacity, and
wherein the second controller of the server
causes the second communication device to transmit the allocated capacity to the image forming apparatus, and
causes, when the second communication device receives the log data for the certain period or the log data segments, the second storage device to store the log data for the certain period or the log data segments.

3. The image forming system according to claim 2, wherein the first controller of the image forming apparatus causes the first communication device to transmit the log data segments to the server at timings different from each other.

4. The image forming system according to claim 2, wherein the first controller of the image forming apparatus causes, when the first communication device has received priorities of a plurality of types of log data transmitted from the server, the first communication device to transmit the log data segments to the server in order from a highest priority.

5. The image forming system according to claim 2, wherein, when the second communication device starts reception of the log data for the certain period or the log data segments, the second controller of the server determines a communication rate for the reception, calculates a communication time required for the reception based on the communication rate and a data amount of the log data or the log data segments as a reception target, and causes the second communication device to transmit an instruction to request stopping of the transmission of the log data or the log data segments as the reception target or an instruction to request a retransmission in which a data amount of the log data or the log data segments as the reception target is reduced to the image forming apparatus when the communication time exceeds a specified time set in advance.

6. The image forming system according to claim 5,
wherein the second controller of the server causes the second communication device to transmit an instruction to request the stopping of the transmission or the retransmission and an instruction to request shortening of the certain period, to the image forming apparatus,
wherein the image forming apparatus further includes a display device and an operation device to which an instruction of a user is input, and
wherein the first controller of the image forming apparatus
causes, when the first communication device receives the instruction to request the shortening, the display device to display a screen for prompting the user to input a new certain period, and
generates the log data segments on the basis of the new certain period when the new certain period is received via the operation device.

7. The image forming system according to claim 1, wherein the first controller of the image forming apparatus counts the certain period only in a state in which the image forming apparatus is operating.

8. The image forming system according to claim 1,
wherein the second controller of the server causes the second communication device to transmit a designated period designating the certain period to the image forming apparatus, and
wherein the first controller of the image forming apparatus generates the log data segments when the log data generation period has reached the designated period if the first communication device has received the designated period.

9. An image forming apparatus comprising:
a first communication device that performs data communication with a server;
a first storage device; and
a first control device includes a processor and functions, when the processor executes a first control program, as a first controller that generates log data related to an operation of the image forming apparatus, causes the first storage device to store the log data, generates, when a log data generation period has reached a certain period set in advance, log data segments by dividing log data for the certain period into a predetermined data amount or less, and causes the first communication device to transmit the log data segments to the server.

10. The image forming apparatus according to claim 8, wherein the first controller
Determines, when the first communication device receives an allocated capacity transmitted from the server, whether or not a data amount of the log data for the certain period is less than or equal to the allocated capacity,
causes the first communication device to transmit the log data for the certain period to the server without performing the division when the data amount of the log data for the certain period is less than or equal to the allocated capacity, and
generates log data segments by dividing the log data for the certain period into the allocated capacity or less and causes the first communication device to transmit the log data segments to the server when the data amount of the log data for the certain period exceeds the allocated capacity.
